(19) United States
(12) Patent Application Publication
(10) Pub. No.: US 2010/0331165 A1
(43) Pub. Date: Dec. 30, 2010

(54) SEALING COMPOSITE FOR FLAT SOLID OXIDE FUEL CELL STACK HAVING HIGH FRACTURE RESISTANCE AND THE FABRICATION METHOD THEREOF

(76) Inventors: Jong-Ho Lee, Seoul (KR); Hae-Weon Lee, Seoul (KR); Joo-Sun Kim, Gyeonggi-Do (KR); Hue-Sup Song, Seoul (KR); Ji-Won Son, Seoul (KR); Hae-Ryoung Kim, Seoul (KR); Sung-Moon Kim, Seoul (KR); Hyoung-Chul Kim, Seoul (KR); Hwa-Young Jung, Incheon (KR)

Correspondence Address: OSTROLENK FABER GERB & SOFFEN, 1180 AVENUE OF THE AMERICAS, NEW YORK, NY, 100368403, US

(21) Appl. No.: 12/438,608

(22) PCT Filed: Dec. 8, 2006
(86) PCT No.: PCT/KR06/05361

§ 371 Date: Sep. 10, 2010

(30) Foreign Application Priority Data
Aug. 28, 2006 (KR) 10-2006-0081976

(51) Int. Cl. C03C 14/00

(52) U.S. Cl. 501/32

(57) ABSTRACT

A composite sealant of the present invention increases a fracture toughness of glass which has an excellent gas tightness but has a low fracture resistance, to enhance the thermal cycle stability while maintaining the gas tightness of a stack. For this, alpha-alumina fiber particles, alpha-alumina granular particles, and metallic particles are mixed and added to a glass matrix for remarkably increasing the fracture toughness from 0.5 MPa·m05 to 6 MPa·m°'5 through the multiple effects of crack deflection and crack bridging by the fiber and granular particles, and effects of crack arresting and plastic deformation by the metallic particles. When using the high fracture toughness composite sealant of the present invention, since the gas tightness and the stability of the stack can be maintained even when there is a thermal stress produced by a non-uniform temperature distribution or a thermal cycle condition in the stack, increasing the fracture toughness of the composite sealant works as the most important factor for enhancing the reliability of a large-area stack.

### TECHNICAL FIELD

The present invention relates to a composite sealant for a planar type solid oxide fuel cell stack having a high fracture resistance, and more particularly, to a planar type solid oxide fuel cell stack having a high fracture resistance by having an increased fracture toughness of glass which has a low fracture resistance, even though it has an excellent gas tightness as a sealing material at a high temperature, in order to enhance the stability and durability of a solid oxide fuel cell, and to the preparation process thereof.

### BACKGROUND ART

A sealing material is inserted between interconnectors and electrolytes in a planar type solid oxide fuel cell so that a fuel gas supplied to an anode and air supplied to a cathode are not allowed to be mixed with each other.

Currently, various sealing materials have been used, and it is reported that a glass-ceramic composite sealant has the best gas-tightness. In spite of its excellent gas-tightness, the glass-ceramic sealing materials having glass as a matrix have a low mechanical strength and also its fracture toughness representing its resistance to fracturing is only about 0.5 MPa·m^{0.5}, so it is very vulnerable to the thermal stress produced by a non-uniform temperature distribution or a transient stress under thermal cycle condition, and accordingly the stability and durability of the stack may be deteriorated.

Therefore, it is one of the most important factors to increase the fracture toughness of the composite sealant having glass as the matrix for enhancing mechanical reliability of the composite sealant so as to obtain stability and durability of the solid oxide fuel cell stack.

### DISCLOSURE OF THE INVENTION

To solve the above problem, the present invention is directed to increasing the fracture toughness by adding multiple reinforcing particles to a glass matrix for enhancing the fracture resistance to a stress developed in a stack and to enhancing the reliability of the stack.

To achieve this object, a composite sealant for planar type solid oxide fuel cell stack in accordance with an aspect of the present invention includes alpha-alumina fiber reinforcing particles of an average grain size smaller than 0.2 μm an in a glass matrix.

Herein, the sealing material may further include granular alpha-alumina powders.

Also, the sealing material may further include metallic powder particles. Herein, preferably, the metallic powder particles are coupled on a surface of the granular (particulate) alpha-alumina powders.

Furthermore, to achieve the above object, a composite sealant for a planar type solid oxide fuel cell stack in accordance with another aspect of the present invention includes, in a borosilicate glass matrix, alpha-alumina particles, as crystallization inhibitor of the glass matrix, and alpha-alumina fiber reinforcing particles and metal particulate reinforcing particles for increasing the fracture toughness of the glass matrix.

Moreover, to achieve the above object, a fabrication method of a composite sealant for a planar type solid oxide fuel cell stack in accordance with another aspect of the present invention comprises preparing alpha-alumina fiber particles having an average size grain size smaller than 0.2 μm after a heat treatment of alumina fibers at 1200˜1400° C., and adding the alpha-alumina fiber particles to a glass matrix.

Herein, preferably, the alpha-alumina fiber particles are extruded and oriented in one direction.

Also, composite powder particles fabricated by a dry milling of granular alpha-alumina particles and metallic particles may be uniformly distributed with excellent chemical homogeneity in the glass matrix.

Further, the composite powder particles and the alpha-alumina fiber particles may be treated by a wet milling.

### EFFECT OF THE INVENTION

The easiest method to obtain gas-tightness of a solid oxide fuel cell stack under a high temperature is using glass that forms a contact interface with electrolytes or metallic interconnects by a viscous flow. When using a glass sealing material, it is very difficult to obtain a long-time stability and thermal cycle stability of the stack due to a low fracture toughness and a crystallization of the glass. Therefore, the composite sealant provided by the present invention performs the role of enhancing the reliability of the solid oxide fuel cell stack as well as that of the sealing material itself, as the fracture toughness (0.5 MPa·m^{0.5}) which is the inherent weakness of glass as a sealing material has been remarkably increased. Particularly, when the composition of the composite sealant is optimized, the orientation of the fiber particles which act as a reinforcement is adjusted, and metallic particles are uniformly distributed, the fracture toughness of the composite sealant reaches nearly 6 MPa·m^{0.5}, which is a fracture toughness nearly ten times as high as a glass sealing material.

Therefore, on using a composite sealant having the composition of the present invention, the generation and growth of cracks can be much more effectively restrained under the same stress conditions to minimize damage of the sealing material. It can not only minimize the damage of the sealing material, which occurs during a cooling process of a thermal cycle, but also recover a gas tightness of the stack as the cracks are filled up during a reheating process.

### BRIEF DESCRIPTION OF THE DRAWINGS

FIG. 1 illustrates the result of X-Ray diffractometry of alumina fibers in accordance with change of a heat treatment temperature.

FIG. 2 is a scanning electron microscope photo showing changes in the grain size of alumna fiber in accordance with heat treatment temperature at (a) 1400° C. and at (b) 1250° C.

FIG. 3 illustrates the result of X-Ray diffractometry in accordance with the size of granular alpha-alumina powders.

### MODES FOR CARRYING OUT THE PREFERRED EMBODIMENTS

To obtain the reliability of a solid oxide fuel cell stack, a long-time stability and a thermal cycle stability of a unit cell, an interconnector (bipolar plate), and a sealing material comprising the stack should be excellent. The present invention provides a composition of a composite sealant having remarkably increased fracture toughness by adding stiffener (reinforcement) particles for enhancing the mechanical reliability of a glass matrix which has a fracture toughness less than 0.5 MPa·m^{0.5} and the fabrication method thereof.

Alpha-alumina fibers (aspect ratio 10-100) are used as the stiffener included in the composition of the composite sealant of the present invention. Further, alumina particles (diameter 0.2-5 μm) and/or metallic particles can be used together. The alumina particles and the fibrous stiffener increase the fracture toughness by a crack deflection and a crack bridging, while the metallic particles increase the fracture toughness by a crack arresting and a plastic deformation. The alumina fibrous stiffener should have a high mechanical strength and a low surface roughness to have a low interfacial adhesion for facilitating the crack deflection or the crack bridging. On the other hand, when the metallic particles having a low modulus of elasticity are distributed uniformly in the glass matrix, fracture energy is consumed by the plastic deformation of the metallic particles, and thereby crack propagation can be restrained.

To distribute metallic particles mixed with glass and a ceramic oxide uniformly, in the present invention, the alumina particles and the metallic particles are mixed and a dry milling is performed to uniformly distribute the metallic particles throughout the whole sealing material by using a method of coating the finely pulverized metallic particles on the surface of the ceramic particles.

A glass matrix composite sealant prepared by the composition and a mixing method of the present invention generally has a high fracture toughness reaching about 6 MPa·m^{0.5} which is 10 times higher than the glass matrix itself, 0.5 MPa·m^{0.5}, and accordingly it can have a high fracture resistance with respect to a stress developed in a stack and enhance the stability of the stack.

Hereinafter, embodiments of the composite sealant and the preparation method thereof in accordance with the present invention will be described in detail.

The first most important composition variable relating to the glass matrix composite sealant relates to the method of optimizing the microstructure of the alumina fibers, which act as a reinforcement inclusion in the glass matrix to enhance the fracture toughness of the composite sealant.

Since most ordinary alumina fibers have an amorphous or a low temperature transition phase (delta phase or gamma phase), they cannot effectively retard the crystallization of the glass matrix. Therefore, it is required to convert them into an alpha phase by a heat treatment at a high temperature. However, the heat treatment at high temperature inevitably increases the grain size, so it causes the mechanical strength of the fibers to be degraded (Z. R. Xu et al., Mat. Sci. and Eng., A171 (1993) 249-256).

Therefore, it is required to perform the heat treatment under conditions capable of maintaining the grain size at the minimum size while converting the alumina fibers into the alpha phase. When the alumina fibers (Rath Co, Germany) used in the present invention are treated by heating at 1250° C., they are found to maintain a very excellent microstructure maintaining an average size of grain 0.03 μm while having the alpha phase as the most prominent structure phase and to maintain a high mechanical strength.

The composite sealant prepared by using the fine-grained alpha-alumina fibers heat-treated at 1250° C. as a reinforcement exhibits a high value of fracture toughness reaching 4.0 MPa·m^{0.5} since the mechanical strength of the alumina fibers increases due to finer grain size and the surface roughness decreases. Meanwhile, when fiber particles heat-treated at 1400° C. are added as a reinforcement, the fracture toughness of the composite sealant is indicated as 2.7 MPa·m^{0.5}, as although it enhances the fracture toughness of the glass matrix, it does not obtain the fracture toughness of the composite sealant containing alumina fibers heat-treated at 1250° C. due to substantially coarser grain size. Also, the fracture toughness of a composite sealant heat-treated at a temperature lower than 1200° C. does not approach the fracture toughness of the composite sealant containing alumina fibers heat-treated at 1250° C. Therefore, it is preferable to heat-treat the alumina fiber particles in the temperature range of 1200˜1400° C.

Preferably, the average grain size of the alpha alumina fibers is below 0.2 μm. If the grain size is over 0.2 μm, the strength of the fibers themselves is degraded, so that if these fibers are added to the glass matrix, the fracture toughness is less effectively enhanced.

The ordinary alumina fibers should be converted to an alpha phase through heat treatment and obtain a condition capable of maintaining the grain size resulting from the transformation at a minimum to obtain a high toughness and a high reliability of the composite sealant by optimum alumina fibers.

Once the optimum alpha alumina fibers are obtained, they are required to be obtained in an appropriate content. The optimum content should be determined between the minimum content capable of restraining a crystallization of the glass matrix and the maximum content capable of aligning fiber particles in a stacking process without a process flaws such as clusters between the fibers in the preparation process.

To restrain the crystallization of the glass matrix, at least more than 5% of fibers is needed, but when more alpha-alumina needs to be added, granular alpha-alumina particles can be added together with the alumina fibers.

On the other hand, the maximum content is greatly influenced in accordance with the aspect ratio since the threshold value for the formation of a interconnected network structure varies with the aspect ratio of the fiber particles. The aspect ratio, the ratio of the length to the diameter of the fiber particles, may be in the range of 10˜100.

With a given aspect ratio, since the packing structure of the fiber particles plays an important role in determining the maximum content of fiber particles, the maximum content of the fibers is largely changeable in accordance with the preparation process affecting the packing structure and alignment of the fiber particles. For instance, when fiber particles having an aspect ratio of 25 are added, the threshold value for forming a three-dimensional network structure in random close packing condition is just about 20 vol %, while fiber content reaching almost 50% can be added in unidirectional alignment condition. As the fiber content of the composite increases, the mechanical strength and fracture toughness of the composite sealant increase, and accordingly, when a composite sealant having a unidirectionally aligned network structure having an orientation in one direction is required to be prepared and applied, a high content of fiber particles are required to be added.

Generally, to form the unidirectionally aligned network structure, it is preferable to utilize an extrusion molding facilitating the unidirectional alignment of the fiber particles under a high shear stress condition, and to form a three-dimensional network structure, a uniaxial pressing of thermal-sprayed granules can be utilized. To obtain a two-dimensional random orientation which is approximately in the middle between the unidirectional orientation and the 3-D random orientation, a tape casting method or a uniaxial pressing of low-density granules can be utilized.

Therefore, the maximum content of the fibers can be adjusted in the range of 20-50 vol % in accordance with the molding method for determining the extent of the orientation of the fiber particles with respect to the given aspect ratio of the fiber particles. Another consideration together with the maximum content of the fiber particles is that the mechanical property exhibited by the composite sealant in accordance with the orientation of the fiber particles has an orientation effect. When a stress is applied in a vertical direction with respect to a longitudinal direction of the oriented fiber particles, the composite sealant exhibits a maximum strength and a maximum fracture toughness, and accordingly, to fabricate a reliable stack, it is required to actively promote the orientation of the fiber particles, not simply to add the fibers in a content as great as possible. Particularly, on operating the stack in a pressurized condition, the mechanical strength and the fracture toughness of the composite sealant in which the fiber particles are oriented in a vertical direction with respect to pressure of gas applied on a surface of the sealing material are very excellent and the reliability of the stack can be greatly enhanced compared with a case having an irregular arrangement state. Therefore, in the stack operated in the pressurized condition, the composite sealant with the fiber particles oriented in one direction in the vertical direction with respect to the direction in which a gas pressure is exerted is expected to be most effective, and the orientation of the fiber particles can be easily obtained through extrusion molding.

A second composition variable regarding the composite sealant relates to a method of additionally adding metallic particles such as Silver (Ag), Palladium (Pd), Gold (Au), Platinum (Pt), Nickel (Ni), Fe—Ni alloy, and Molybdenum (Mo) together with the alumina fiber particles capable of enhancing the fracture toughness of the composite sealant, restraining the generation of cracks due to thermal stress, reducing the propagation distance of any crack generated, and restraining the growth of cracks while consuming a part of the fracture energy by a plastic deformation of the metallic particles themselves.

To distribute the metallic particles uniformly throughout the entire composite sealant, it is most effective to form composite powder particles through a dry milling with granular alumina particles additionally added to the composite sealant. Granular alpha-alumina powders are separated into fine particles as agglomerates are broken down, and soft metallic powders cover the surface of the alumina particles as a plastic deformation has occurred by a milling energy. Thereby, it is possible to obtain composite powders having an excellent mixing homogeneity as a whole. The composite powders fabricated by the dry milling method are mixed with alpha-alumina fiber powders to carry out a wet milling for more uniformly distributing the metallic powder particles.

A mixture of the granular alumina powders and Silver powder particles obtained through a dry milling was mixed with glass matrix powder, and then the mixture was homogenized through a wet milling, whereby a composite was obtained. On measuring and comparing the fracture toughness of the composite with added Silver powder and the composite without the added Silver powder, it was confirmed that the fracture toughness value of the composite in which the Silver powder was added in an amount of 0.47% increased by more than about 130%. This showed that the fracture toughness remarkably increased if only small amount of metallic powder particles were added to a composite sealant including granular alumina particles.

When the glass matrix composite sealant having the optimum composition was prepared using the alpha-alumina fibers and the metallic powder particles as reinforcements at the same time and including the granular alumina for restraining the crystallization of the matrix glass, a fracture toughness value of 6.0 MPa·m^{0.5} was obtained, which is nearly 10 times higher than the value of a composite only including the conventional granular alumina. To obtain the maximum fracture toughness value, borosilicate glass powders, alumina fiber powders heat-treated in the optimum condition as described above, and alumina-metal composite powders mixed by a dry milling are uniformly mixed with a binder system which is a processing aid through a wet milling, and the mixture is prepared in a granular form or a tape form and fabricated into a gasket having a preferred shape for being applied as a sealing material in the fabrication process of the stack.

Although the fracture toughness increases in accordance with increasing of the content of the metallic powder, the sealing material may have an electrical conductivity if there is too much content of metallic powder, so it is required to maintain the metallic particles in an isolated state if possible. To obtain a distribution of the metallic particles in the isolated state, the content of the metallic powder should not be over 20% of the total volume of constituent materials of the sealing material, and if using a composite powder prepared by the dry milling method, it is preferable that the volume content of the composite powder is not over 20%. In a process of densifying the composite sealant by a viscous flow, although granular and fiber alumina powder particles and metallic particles are hardly densified. When a network structure is formed between the non-densifying reinforcements the densification of glass matrix is decreased. Even with densification of composite sealant, the non-densifying particles can hardly be mobilized. But the connectivity the metal can be be greatly increased with the help of preferential alignment of reinforcement particles, whereby it is preferable to adjust the granular alumina content coated with metallic particles to below 20% if possible.

A third composition variable regarding the sealing material is the granular alpha-alumina powder restraining the crystallization of the matrix glass, and the effect of preventing the crystallization depends on the size and the content. It is effective that alpha-alumina powder particles are dispersed to restrain the formation of cristobalite in an silica excess area due to local changes in the composition of the glass matrix, which shows that as the size of the contact interface of the glass matrix and the alpha-alumina particles becomes larger, the crystallization of the glass matrix is more restrained. Therefore, since the area of the interface is in accordance with the size of the alpha-alumina, so the content is required to be adjusted corresponding to the above.

### Example 1

### Effect of Metallic Silver Addition for Enhancing the Fracture Toughness of an Alumina Particles/Borosilicate Glass Composite Sealant

To observe the effect of adding metallic silver particles for enhancing the fracture toughness of an alumina particles/borosilicate glass composite sealant, first, Pyrex glass manufactured by Iwaki Co., Ltd, Japan was reduced to powder having a size of 5 microns. The glass powder was milled in a non-aqueous solvent (ethanol+acetone), organic additives such as a binder and a plasticizer were added, and finally, alumina fibers were mixed to prepare a slurry and the slurry was sprayed over distilled water which was a non-solvent to form uniform porous granules. If necessary, silver powder (Sigma-Aldrich) having a size of 5.6 microns can be added in the amounts of 0, 3, 5 and 10 wt % by dry-milling together with alumina particulates. After compression molded sealing gasket were heat-treated for 2 hours at 800° C. nearly identical to operation condition, the fracture toughness strength was measured through a scale indentation method.

TABLE 1
Changes in fracture toughness in accordance
with adding of silver powder

| Ag Powder (wt %) | 0 | 3 | 5 | 10 |
|---|---|---|---|---|
| K_{IC}(MPa · m^{0.5}) | 3.4 | 3.5 | 4.4 | 4.7 |

As shown in Table 1, on adding ductile silver metallic particles, cracks were induced towards metallic silver particles, and accordingly, fracture energy was consumed by the plastic deformation, whereby propagation of the cracks was restrained, so the fracture toughness was increased.

### Example 2

### Enhancement of Fracture Toughness of a Composite Sealant in Accordance with the Heat Treatment Condition of Alumina Fiber Particles

To observe the enhancement effect of the fracture toughness of the composite sealant in accordance with the heat treatment condition of the alumina fiber particles, ‘Rath 97 ’ alumina fibers comprised of 97% alumina and 3% silica were milled for 1 hour and calcined for 1 hour at 1400° C. and for 4 hours at 1250° C.

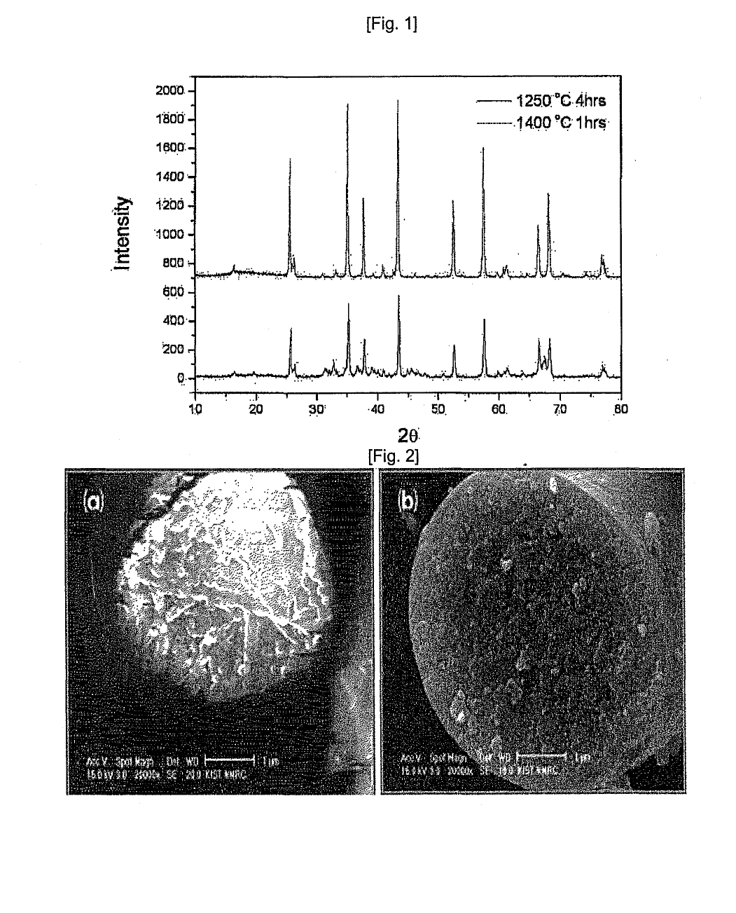

As shown in FIG. 1, amorphous alumina fibers were calcined under both conditions and converted to an alpha alumina phase. Through observing the microstructures (FIG. 2) of the alumina fiber particles calcined at 1250° C. and 1400° C., they showed average grain size of 0.03 and 0.2 microns, respectively. The alumina fibers prepared by this method were granulated through the liquid condensation technique presented in the previous example, and were molded through a compression molding method. The molded bodies obtained were treated by heating for 2 hours at 800° C., and their fracture toughness was measured through a scale indentation method.

The fracture toughness of the composite sealant prepared by using the alumina fibers heat-treated at 1250° C. for 4 hours and 1400° C. for 1 hour, respectively, by the scale indentation method, were indicated as 4.0 and 2.7 MPa·m^{0.5}. In case of the sealing material using alumina fibers treated by heating at 1400° C., the mechanical strength increases, and the fracture toughness of the glass matrix is enhanced, but the fracture toughness thereof does not reach that of the composite sealant treated by heating at 1250° C., which has a finer grain structure.

### Example 3

### Effect of Metallic Particle Addition for Enhancing the Fracture Toughness of an Alumina Fiber Reinforced Glass Matrix Composite Sealant

To observe the effect of metallic particle addition on the fracture toughness of an alumina fiber reinforced glass matrix composite sealant, silver powder having a size of 5.6 microns was treated by dry milling with ALM-43 granular alumina particles Sumitomo Chem. Co., Ltd, Japan having an average particle size of particles of 2.5 microns, and treated again by wet milling for 1 hour, and thereby a composite powder having an excellent mixing homogeneity was obtained. The composite powder was milled with Pyrex glass powder having a particle size of 5 microns in a non-aqueous solvent (ethanol+acetone) and organic additives such as binder and plasticizer were added to the powder. Finally, alumina fibers calcined for 4 hours at 1250° C. were added to prepare a slurry and the slurry was sprayed over distilled water which was a non-solvent to form uniform porous granules. After the sealing gasket was compression-molded and heat-treated at 800° C. for 2 hours, the fracture toughness is measured through a scale indentation method.

TABLE 2
Effect of metallic particle addition on fracture toughness

| Calcination | Calcination Time | Ag Powder | K_{IC} |
|---|---|---|---|
| Temperature (° C.) | (hr) | (vol %) | (MPa · m^{0.5}) |
| 1400 | 1 | 0 | 4.3 |
| 1250 | 4 | 0 | 5.0 |
| 1250 | 4 | 0.47 | 6.0 |

As shown in Table 2, in case of a sealing material using alpha-alumina fibers and metallic powder particles as multiple reinforcements, the fracture toughness of the sealing material was higher than that of a composite sealant to which only the alpha-alumina fibers were added as the reinforcement by additional toughening effect through the crack arresting effects obtained by addition of the ductile particles such as the silver particles, the plastic deformation of the metallic particles, and the crack deflection and crack bridging by the alumina particles.

### Example 4

### Crystallization Restraining Effect of a Borosilicate Glass Matrix in Accordance with the Size and Content of Alpha-Alumina Particles

To observe the restraining effect of the crystallization of a borosilicate glass matrix in accordance with the size and content of alpha-alumina particles, ALM-43 alumina particles of Sumitomo Chem. Co., Ltd, Japan having an average particle size of 2.5 microns and AKP-30 alumina particles having a particle size of 0.3 micron were mixed with glass powder and alumina fibers, respectively, and then granulated through a liquid condensation method. The sealing gaskets were prepared by compression molding and densification at 800° C. for 2 hours, and a phase analysis was performed through a scale indentation method.

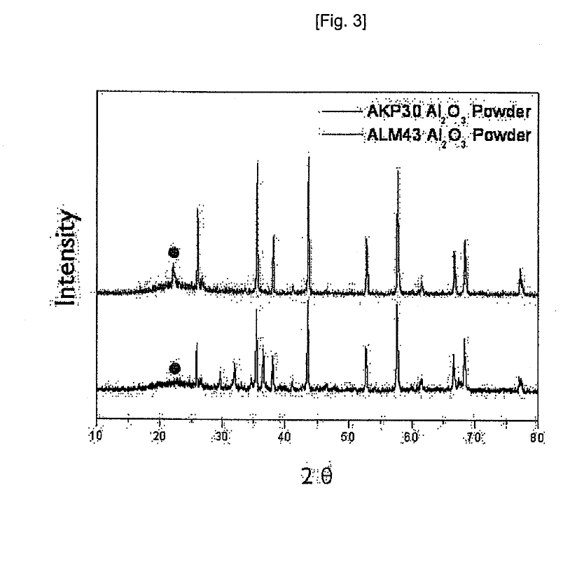

As shown in FIG. 3, as the alpha-alumina powder granules become smaller, the formation of cristobalite in an silica excess area due to local changes in the composition of the glass matrix is restrained more effectively.

1. A composite sealant for a planar type solid oxide fuel cell stack, comprising alpha-alumina fiber reinforcement particles, composed of fine grains smaller than 0.2 μm, in a glass matrix.

2. The composite sealant of claim 1, wherein the content of the alpha-alumina fiber reinforcement particles in the sealing material is in the range of 5˜50 vol %.

3. The composite sealant of claim 1, wherein an aspect ratio of length to diameter of the alpha-alumina fiber reinforcement particles is in the range of 10˜100.

4. The composite sealant of claim 1, wherein the alpha-alumina fiber reinforcement particles are unidirectionally oriented.

5. The composite sealant of claim 1, further comprising granular alpha-alumina powder.

6. The composite sealant of claim 5, further comprising metallic powder particles.

7. The composite sealant of claim 6, wherein the metallic powder particles include the one selected among Silver (Ag), Palladium (Pd), Gold (Au), Platinum (Pt), Nickel (Ni), Fe—Ni alloy and Molybdenum (Mo).

8. The composite sealant of claim 6, wherein the metallic powder particles are coupled on the surface of the granular alpha-alumina powder.

9. The composite sealant of claim 8, wherein a content of composite powders, which are coupled bodies of the granular alpha-alumina powder and the metallic powder particles, is below 20 vol %.

10. A composite sealant for planar type solid oxide fuel cell stack, comprising, in a borosilicate glass matrix, alpha-alumina particles as a crystallization inhibitor of the glass matrix, and alpha-alumina fiber particles and metal particulate particles, as multiple reinforcements increasing fracture toughness of the glass matrix in a borosilicate glass matrix.

11. A preparation process for a composite sealant for a planar type solid oxide fuel cell stack, comprising:
preparing alpha-alumina fiber particles having an average alumina grain size smaller than 0.2 μm after a heat treatment of alumina fibers at 1200˜1400° C.; and
adding the alpha-alumina fiber particles to a glass matrix.

12. The preparation process of claim 11, wherein the alpha-alumina fiber particles are extruded and oriented in one direction.

13. The preparation process of claim 11, wherein composite powder particles, prepared by dry milling of granular alpha-alumina particles and metallic particles, are uniformly distributed in the glass matrix.

14. The preparation process of claim 13, wherein the composite powder particles and the alpha-alumina fiber particles are further treated by wet milling for better mixing homogeneity and deagglomeration of composite powder particles.
